(19) United States
(12) Patent Application Publication
(10) Pub. No.: US 2005/0057488 A1
(43) Pub. Date: Mar. 17, 2005

(54) Electronic sign in sheet for patients using integration software cryptographically designed to eliminate the paper sign in sheet

(76) Inventor: Shelly Denise White, Dallas, TX (US)

Correspondence Address: Shelly D. White, 1264 Tioga Drive, Irving, TX, 75063, US

(21) Appl. No.: 10/419,317

(22) Filed: Apr. 22, 2003

Related U.S. Application Data
(60) Provisional application No. 60/423,718, filed on Oct. 28, 2002.

(51) Int. Cl. G09G 5/00

(52) U.S. Cl. 345/156

(57) ABSTRACT

Most of the security requirements outlined in the proposed regulations are quite general, and the stated focus of the regulations is to be “technology neutral”. For electronic signatures the proposed requirement is a digital signature. HIPAA will not require the use of electronic signatures. If they are used, however, they must comply with the requirements that will be outlined in the final regulations. Currently the Department of Health and Human Services proposes to adopt a cryptographically based digital signature as the standard. Applying a mathematical function to the electronic document forms a digital signature. This results in a unique bit string, referred to as a “message digest”. Then, the digest is encrypted using the originator's private key. The resulting bit stream is appended to the document and the document is transmitted over a communications network.

This application claim benefit of my provisional application Ser. No. 60/423,718 submitted on Oct. 28, 2002.

The present invention relates to a new method and system for the replacement of the traditional paper sign in sheets at healthcare facilities. Utilizing an electronic device, such as, signature capture point of sale equipment, can replace paper or computer generated paper sign in sheets. In light of the Health Insurance Portability and Accountability Act of 1996 (HIPAA) and Privacy Laws, the methods will comply and enhance the current regulations of privacy. This law comes into effect on Apr. 14, 2003. The electronic signing method has a variety of uses that will benefit the patient, provider and the insurance company.

With electronic sign in the provider can also: accept credit card payments, electronically process checks and accept large amounts of money for payment of non-covered health services and un met deductibles. This method will also bind the electronic signature to the document and authenticate the patient's identity, which is beneficial to the Insurance Company. The patient's signature will then be on file and retrievable for future purposes. Upon returning, the patient can either use the electronic process or input the last four digits of their social security number as a personal identification number (PIN) to retrieve their records. This procedure will be the way the person continues to sign in at that particular health care facility. The unique social security number process will further validate the person's identity and alleviate errors.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR COMPUTER PROGRAM LISTING COMPACT DISK APPENDIX

Not Applicable

### BACKGROUND OF THE INVENTION

Today, most hospitals, pharmacies, doctors, health plans; and other health care entities use paper sign in sheets. This “sign in” method serves as part of the facilities basic operating procedures. This method is used for various reasons such as: process patients at check-in/out and track those who did/did not show up for their appointment. The paper sheets have been in use prior to new Privacy Laws. They are used on a daily basis and filed and archived depending on the facility. This paper sign in sheet is also used in conjunction with billing, daily totals, and month end information et cetera.

When a patient goes to a Doctor's office or any other Health Care facility, there should be a device or private procedure that does not leave their information visible by the next patient or visitor. Lab work, patient charts, billings, and messages are all part of a facility and must be protected. These tangible items are all private information relating to use in health care.

The Internet is the most widely used communication/information portal in our society today. The Internet serves as a gateway to easily access personal information. There are presently no protections for its use, just firewalls in which hacker's can still break through. The Internet can provide an individual's driving records, past addresses, marriage/divorce information, phones numbers, baking information, credit reports (just to name a few) with small pieces of information. The paper sign in procedure will continue to contradict the current Privacy Laws.

If those laws are for Americans, then there should be greater constraints on privacy.

The problems with sign in sheets include:
Private information is accessible and possibly read by the next patient, delivery person, sales person et cetera.
Identity theft highest reported crime nationally, patients information is easily accessible on theses sheets
Embarrassing confrontations with someone you may know and may not want to know any longer can find out where you are presently reside, phone number as well as the facility you go to for treatment.
Contact information on display can easily be copied
No protection from facility, no assurance information is not visible
   Unbeknownst to office staff, simply signing a sheet to see the doctor, pharmacist, therapist, or related entities may put someone is danger of being a victim of identity theft, followed or stalked.

In private research of this topic, people have actually witnessed others looking up and down a sign in sheet for familiar names, writing down phone numbers and one account of an individual taking the entire sheet. In certain communities, Physicians, Clinics and other facilities are known for treating individuals for certain diseases, symptoms and specialties such as AIDS, Acquired Immune Deficiency Syndrome, STD's, sexually transmitted diseases and low income individuals. Americans should be able to visit with his/her physicians and facilities. These visits must be as private as possible without the potential of their information accessible and without embarrassment. It is inevitable to run in to someone you know, but is should not be that you notice someone's name on a sign in sheet.

There are many variances of patient paper sign in sheets. A patient's personal information is always vulnerable. It does not take a large amount of information for a person to surf the net and cross check. Some search engines, private investigative companies and many or our browsers have fields that only require a first initial and last name city and state.

For example, patient A goes in for a prostate exam. He discretely signs in and waits to be seen. Minutes later, patient B comes in and notice while signing in on the sheet, patient A's name. Now, depending on the relationship, personal or professional, the Urologist office may not be an appropriate place to have personal or business conversation. There can be a sense of embarrassment on both parties. There can also be the same situation at an abortion clinic. Patient A brings her minor daughter in for an exam or just a consult. Meanwhile, another patient shows up with her parent/guardian and sees the other young lady. This situation can get ugly if both attend the same high school, church, or girl scouts camp.

All segments of health care industry have expressed their support for the objective of enhanced patient privacy in the health care system. HIPAA contains stronger security standards for using electronic signatures than the standards in the recently enacted electronic signature law, also known as E-Sign. It is those higher standards that physicians should adopt if they decide to use electronic signatures, Dr. Zubeldia said. But it is not as if doctors have the option of choosing the standards of the newly signed legislation over HIPAA'S standards.

Sutter Medical Group, for example, plans to implement digital signatures by year end, enabling doctors to electronically sign orders and x-ray readings, communicate with each other and access patient data from home in a secure environment, said John M. Whitelaw Jr., MD, CEO of the 175-physician multi-specialty group in Sacramento, Calif. By using digital signatures, the group's doctors will be able to reduce paperwork and avoid playing phone tag with colleagues and other caregivers, thus delivering quicker care to patients, Dr. Whitelaw said. “It will improve patient care and save time.” According to Dr. Jim Brooking, CIO of the North Carolina Healthcare Information and Communications Alliance, some web sites offer free digital certificate; however, these do not provide adequate security for medical applications because applicants don not need to present proof of identity and medical qualifications to obtain the certificates. Something must be done to establish a procedure that enhances HIPAA and Privacy. Apr. 14, 2003 is the date mandated by the Department of Health and Human Services, Office of Civil Rights. All health care facilities must comply with HIPAA this after their publication in the Federal Register.

John M. Whitelaw Jr., MD, CEO, Sutter Medical Group, multi-specialty group in Sacramento Calif.

Drs.' Brooking & Zubeldia are with the North Carolina Healthcare Information and Communications Alliance, a non-profit organization.

### BREIF SUMMARY OF THE INVENTION

Our healthcare system has relied heavily on “paper sign in” sheets in our medical facilities across our country. The procedure for signing in has been in use for years prior to recent laws and healthcare compliance changes. The Privacy Rule establishes a federal requirement that most doctors, hospitals, or other health care providers obtain a patient's written consent before using or disclosing the patient's personal health information to carry out treatment, payment of health care operations. An electronic signature, however, can be an electronic sound, symbol or process associated with a record and executed by a person with the intent of signing the record. It could be anything, including a digital signature, an X or simply a name typed at the bottom of e-mail.

Some advantages for employing the use of an electronic signature device are:
Preserves privacy
Provides automation of signing in during the appointment process
Enhance compliance with HIPAA
Captures patient signature which becomes legally binding as if signing an actual piece of paper
Cost savings for providers and Insurance companies
Creates electronic record of the visit
Software will ask regular appointment type questions on screen instead of aloud, giving patient privacy.
Promotes a paperless, automated medical facility or pharmacy.
   Health and Human Service's proposed digital signature standard must incorporate three mandatory technical features or technologies:
No repudiation, which would block a sender's false denial that he or she signed a particular message, thus, enabling the recipient to easily prove that the sender actually did sign the document.
User authentication, a technology that would authenticate the signer's identity at the time the electronic signature is generated.

Message integrity, a feature that would not only bind a signature to a document but also show that the document had not been altered after the signature had been affixed to it. If the document were altered, then the signature would be invalidated. Fortunately, there are technologies that have emerged recently that doctors can use in conjunction with electronic signatures to achieve higher security and data integrity standards that will keep doctors out of trouble, Dr. Zubeldia said. These include digital certificates, signature dynamics, and message authentication technologies.

Before you can digitally sign a document, both you and the person to whom you're sending the document need to acquire digital certificates issued by Internet security firms known as certification authorities and download them into your computer or special equipment attached to your PC. Although most certification authorities charge a fee for a digital certificate, the AMA and Intel are offering the certificates at no cost to physicians.

Thus, it complements (electronic signatures) HIPAA, said Jeanne Scott, director of government relations for NDC Health Information Services, a division of National Data Corp., a software and claims clearinghouse company in Atlanta. “There's far more leeway in this statute than in HIPAA for health care industry groups and business partners. I can see this electronic signature law being used beyond HIPAAS administrative transactions to clinical orders and transactions within one year,” Scott said. “The next step is that we have to establish internally within our own industry a comfort zone among ourselves,” Scott said. “We have to define local rules and customs for how we will do this, how the process will take place and what one party will accept and what another will not. When that comfort zone comes, we will see electronic signatures used in a wide variety of areas.”

Highlights of the Electronic Signatures in Global and National Commerce Act:
Electronic signatures have the same legal weight as signatures inked on paper.
Consumers must consent to use of electronic signatures.
Consumers must be offered the choice of signing documents via electronic means or pen-and-paper.
Electronic signatures cannot be used to cancel health or life insurance benefits except for annuities.
If another statute, regulation or other rule of law requires that certain documents be provided and available on paper, you can satisfy that requirement by having those documents in an electronic format as long as consumers consent to it.
But the said documents can be in an electronic format only if you're capable of storing and reproducing them accurately for later reference. If you can't do that, then the legal effect, validity, and enforceability of the electronic record may be denied.
   Although HIPAA included a requirement for a unique personal health care identifier, HHS and Congress have put the development of such a standard on hold indefinitely. In 1998, HHS delayed any work on this standard until after comprehensive privacy protections were in place. Since 1999, Congress has adopted budget language to ensure no such standard is adopted without Congress' approval. HHS has no plans to develop such an identifier.

### BRIEF DESCRIPTION OF THE SEVERAL VIEWS OF THE DRAWING

NOT APPLICABLE

### DETAILED DESCRIPTION OF THE INVENTION

The electronic patient sign signature capture pad will allow for each individual patient to privately and securely electronically sign their names. Instead of the use of the paper sign in sheet, the electronic sign in sheet has many benefits. When a patient enters the healthcare facility he/she walks up to the reception area and electronically signs in on the signature pad. The small LCD screen will then prompt patient to answer questions such as:
First time visiting our facility?
If not, has your insurance information changed?
Has your phone number or address changed?
Which Physician are you seeing today; list all Physicians at the facility
The questions can vary depending on the specialty/practice/pharmacy or office
In the event of a new patient, the screen will prompt user to ask receptionist for a new patient worksheet. At his next visit he will then use the electronic sign in
At the end of signing in, the system will give him his sign in number in numerical order of the appointment information. This will prevent from calling name aloud.

1. What I claim as my invention is: the use of an electronic sign in sheet that utilizes an e-Pad or signature capture device/software that automates the waiting room and appointment process.

2. What I claim is: Patient information will no longer be accessible to anyone other than office staff and not accessible to the next patient.

3. What I claim is: Electronic sign in sheet has cost savings that are beneficial to the Physician and Insurance Company.

4. What I claim is: my invention for an improved process would comply/enhance HIPAA The Privacy Rule, Patriot Act and other security proposed by the Joint Commission, Congress, and The Department of Health and Human Services.

5. What I claim is: signature process according to the rules of public key technology.

6. What I claim is: the electronic sign in sheet will preserves privacy and create an electronic record of that patient.

7. What I claim is: the electronic sign in sheet is a legally binding document other than a sheet of paper.

8. What I claim is: Non-alterability once the signature has been affixed to the device What I claim is: Authentication of the signer's true identity.

9. What I claim is: Improved use that protects the patient, physician and insurance company.
